(19) United States
(12) Patent Application Publication
(10) Pub. No.: US 2017/0152157 A1
(43) Pub. Date: Jun. 1, 2017

(54) Modular Scalable Desalinization System

(71) Applicants: Robert Patrick Ranger, Phoenix, AZ (US); Mark Louis Kirchner, Phoenix, AZ (US); Joe Richard Arechavaleta, Phoenix, AZ (US)

(72) Inventors: Robert Patrick Ranger, Phoenix, AZ (US); Mark Louis Kirchner, Phoenix, AZ (US); Joe Richard Arechavaleta, Phoenix, AZ (US)

(21) Appl. No.: 15/011,615

(22) Filed: Jan. 31, 2016

Related U.S. Application Data
(60) Provisional application No. 62/188,907, filed on Jul. 6, 2015.
(60) Provisional application No. 62/111,031, filed on Feb. 2, 2015.

(51) Int. Cl. C02F 1/14; H01M 8/0606; B01D 3/00; C02F 1/06; B01D 1/00; B01D 3/06

(52) U.S. Cl. CPC C02F 1/14; B01D 1/0035; B01D 3/06; B01D 3/007; C02F 1/06; H01M 8/0606; C02F 2103/08

(57) ABSTRACT

A solar powered highly efficient modular and scalable desalinization plant, using a typical thermal evaporation desalination unit, hydrogen fuel cells, heat-exchangers, hydride-tanks with a control-manifold with input/output selector, hydrogen generation and a solar power source providing low-cost per unit of potable water and low maintenance. Hydrogen Storage and a fuel cell providing combined heat and power enables the plant to operate continuously.

### CROSS-REFERENCE TO RELATED APPLICATIONS

### U.S. Patent Documents

| | | |
|---|---|---|
| 8,328,996 | Dec. 11, 2012 | St. Germain, et al. |
| 7,073,337 | Jul. 11, 2006 | Mangin |
| 7,422,663 | Sep. 9, 2008 | Costa |
| 7,470,873 | Dec. 30, 2008 | Kozak, III |
| 8,246,787 | Aug. 21, 2012 | Cap, et al. |
| 8,545,681 | Oct. 1, 2013 | Shapiro, et al. |

### BACKGROUND OP THE INVENTION

The human race needs water for its survival. Personal consumption, agriculture, and industry are among a few of the needs. When there are shortages of water all of these needs suffer. Sea water being very abundant on the planet and the seas being the ultimate source of our fresh water sources resulting from the natural weather cycles. When the weather cycles shift and less fresh water is available in regions of the world other measures can be utilized to produce needed fresh water.

Thermal desalinization has been used since the end of the 19th century to produce fresh water on board sea fairing vessels. In recent decades some countries have built desalinization plants close to the sea shores including thermal and reverse osmosis types of plants. Desalinization requires a lot of energy not matter which type is used.

### SUMMARY OF THE PRESENT INVENTION

The current invention derives its energy from a solar photovoltaic collection array large enough to allow for the continuous running of the Modular Scalable Desalinization plant (MSD). The collected energy is then converted to hydrogen that is stored in hydride tanks for future or immediate use by the hydrogen fuel cell. Once the system is in place it will continue to operate continuously with only regular maintenance. MSD is designed to be as efficient as possible reducing the cost of the photovoltaic array and other components.

The MSD can also be configured to use other sources of power in areas or times when solar energy is not available.

### BRIEF DESCRIPTION OF THE DRAWINGS

FIG. 1 is a perspective view of the context of the present invention.

FIG. 2 is a perspective view of major sub-systems of the present invention.

FIG. 3 is a perspective view of the Hydrogen Production Sub-system of the present invention.

FIG. 4 is a perspective view of the Hydrogen Storage Sub-system of the present invention.

FIG. 5 is a perspective view of the Power Generation Sub-system of the present invention.

FIG. 6 is a perspective view of the De-ionize Water Production Sub-system of the present invention.

FIG. 7 is a perspective view of the Heat Recovery Stage of the present invention.

FIG. 8 is a perspective view of the Alternate Power Generation Sub-system of the present invention.

### DETAILED DESCRIPTION OF THE INVENTION:

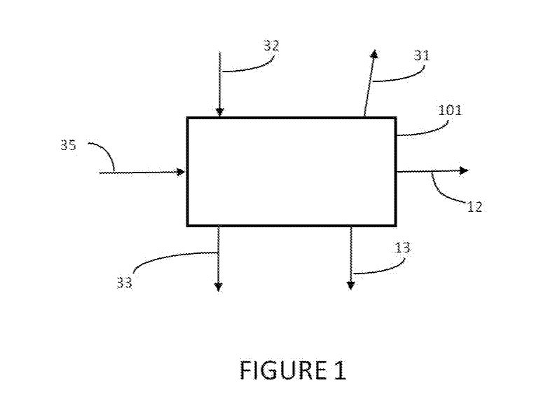

FIG. 1 shows the context of the Modular-Scalable Desalinization Plant 101. Modular-Scalable Desalinization Plant 101 takes Input Water 35, Power Source 32, outputs oxygen to the Atmosphere Oxygen Connector 31, Potable Water 12 and Brine 13. The Brine 13 is returned to an appropriate release location. The release location can be either the original source or an evaporation field. The Potable Water 12 is sent to the end-user. The Power Source 32 can either be from the utility grid or other alternate source.

The Modular-Scalable Desalinization Plant (MSD) 101 (FIG. 1) is capable of storing power during periods when inexpensive power is available for use at a later time to produce Potable Water 12 (FIG. 1). When the power source 32 (FIG. 1) is photovoltaic, or some other source, then the MSD 101 (FIG. 1) will store the energy as hydrogen for use over the period that no photovoltaic power is available. Atmosphere 33 is input to react with hydrogen producing electrical power and heat. Alternately inexpensive power from the grid during off-peak periods can be used to create hydrogen for energy storage. The hydrogen then can be used to generate power needed by the MSD 101 during the peak energy cost periods of the grid. This shifts the power costs of the MSD 101 to the off-peak costs of the grid. If photovoltaic is used as the power source then a sufficient quantity of hydrogen is generated during solar availability and stored to power the MSD 101 for a continuous Twenty Four hour period. The Modular-Scalable Desalinization Plant 101 produces a constant flow of Potable Water 12 from the Input Water 35, using solar energy or the electrical grid as the Power Source 32.

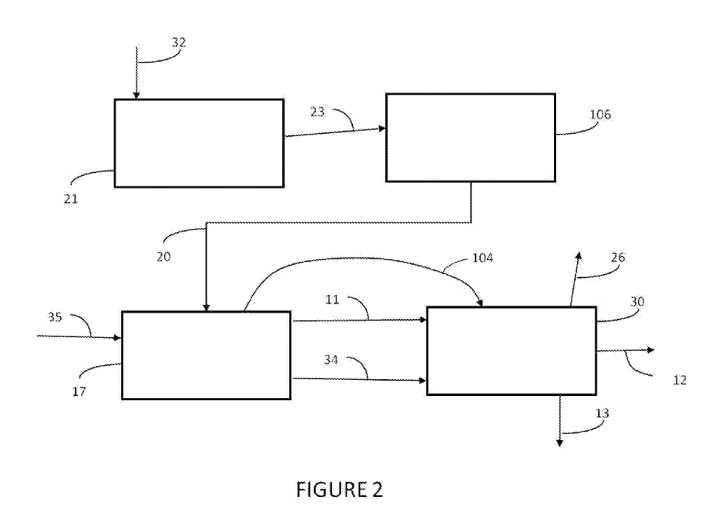

FIG. 2 shows the MSD 101 (FIG. 1) is comprised of four major sub-systems a Flash Type Distilling Plant 30, a Power Generation Sub-system 17, a Hydrogen Storage Sub-system 106, and a Hydrogen Production Sub-system 21. The Power Source 32 is input to the Hydrogen Production Sub-system 21. The Hydrogen Production Sub-system 21 produces and delivers hydrogen to the Hydrogen Storage Sub-system 106 by the Hydrogen Connection 23. The Hydrogen Storage Sub-system 106 delivers hydrogen to the Power Generation Sub-system 17 using the Hydrogen Connection 20. The combined heat and power created by the Power Generation Sub-system 17 is feed to the Flash-Type Distilling Plant 30 by the Steam Connection 11, Power Connection 34, and the Heated Input Brine Water 104. The Input Water 35 is input to the Power Generation Sub-system 17. The Power Generation Sub-system 17 outputs Heated Input Brine Water 104. The Heated Input Brine Water 104 and the Potable Water 12 pressures are monitored and maintained with difference such that the Potable Water 12 pressure is always lower than the Heated Input Brine Water 104. The Steam Connection 11 pressure is monitored and adjusted to maintain optimum inches of mercury vacuum in the evaporators of the Flash Type Distilling Plant 30 for optimum water evaporation. The Potable Water 12 salinity is monitored to determine if the salinity level reaches an unacceptable level and then the delivery of the Potable Water 12 can be shunted to the Brine 13 output thereby not contaminating the downstream usage of the Potable Water 12. The brine pump, and integral part of the Flash Type Distilling Plant 30, status is monitored verifying that it is functioning properly for the removal of the Brine 13.

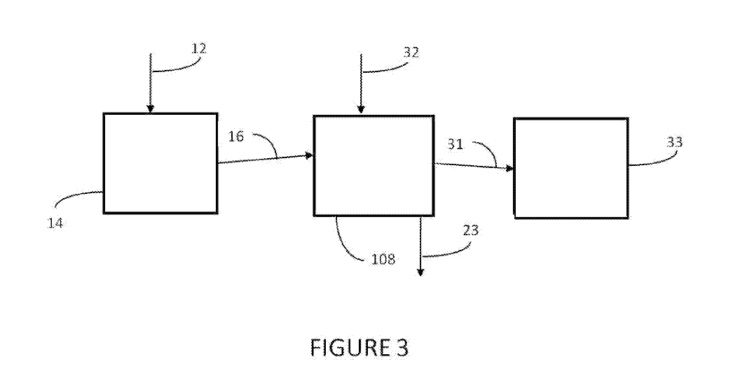

FIG. 3 shows the Hydrogen Production Sub-system 21 is comprised of one De-ionized Water Production Sub-system 14, one or more Hydrogen Generator(s) 108, Hydrogen Connection 23 for hydrogen output, and Oxygen Connection 31 for oxygen output to the Atmosphere 33. The Hydrogen Generator 108 produces hydrogen by separating de-ionized water from the De-ionized Water Connection 16 into hydrogen and oxygen. Fresh Water 43 is input to the De-ionized Water Production Sub-system 14.

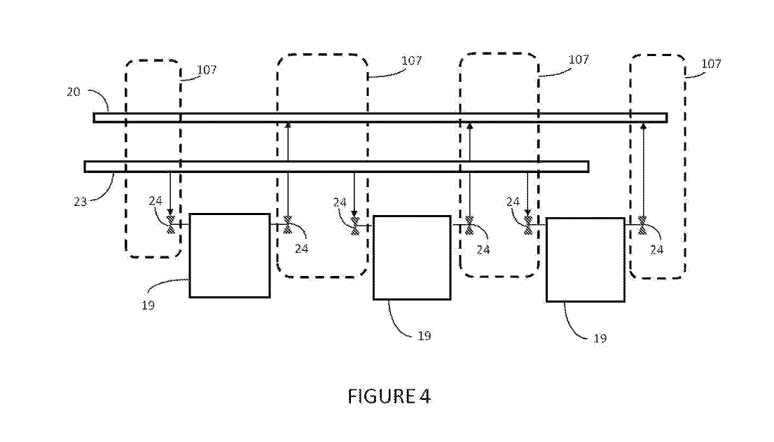

FIG. 4 shows the Hydrogen Storage Sub-system 106 (FIG. 2) is comprised of a series of one too many Hydrogen Hydride Tanks 19 connected to the Control Manifold and Input/Output Selector 107. The Hydrogen Storage Sub-system 106 hydrogen output 20 is connected to the Power-Generation Sub-system 17. The Hydrogen Connection 23 from the Hydrogen Production Sub-system 21 feeds the Hydrogen Storage Sub-system 106. Each Hydrogen Hydride Tank 19 could be one too many tanks connected in parallel. Two too many Hydrogen Hydride Tanks 19 are connected to the Control Manifold and Input/Output Selector 107. The Hydrogen Storage Sub-system 106 output 20 is connected to the Power-Generation Sub-system 17.

FIG. 4 also shows that the Control Manifold and Input/Output Selector 107 provides control of the Hydrogen Input 23 and Hydrogen Connection Output 20 functions to or from the available Hydrogen Hydride Tanks 19. The Control Manifold and Input/Output Selector 107 has one Hydrogen Hydride Tank 19 providing hydrogen to the Power Generation Sub-system 17 with Hydrogen Connection Output 20. Simultaneously the Control Manifold and Input/Output Selector 107 has an alternate Hydrogen Hydride Tank 19 in the Hydrogen Storage Sub-system 106 being recharged by the Hydrogen Production Sub-system 21 with Hydrogen Connection Input 23. The Control Manifold and Input/Output Selector 107 is comprised of Hydrogen Connection Output 20, and Hydrogen Connection Input 23 with a Valve 24 on each Hydrogen Hydride Tank 19 connected to each. Two Valves 24 are required for each Hydrogen Hydride Tank 19 allowing the Hydrogen Hydride Tank 19 to either input or output hydrogen from its storage. The pressure of each Hydrogen Hydride Tank 19 is monitored to determine if the tank can be filled or if it is full and can be used to output hydrogen.

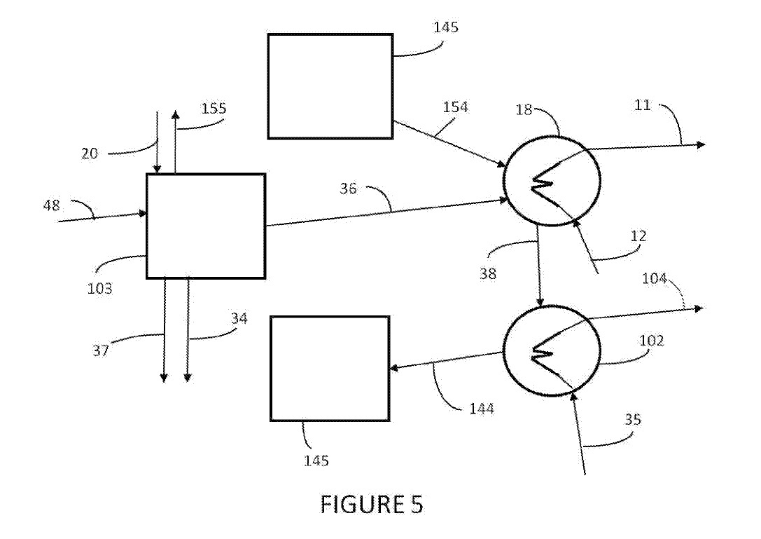

FIG. 5 shows the Power Generation Sub-system 17 (FIG. 2) is comprised of one too many Hydrogen Fuel Cells 103, a Steam Heat Exchanger 18 and a Input Heat Exchanger 102. The Hydrogen Fuel Cells 103 receives hydrogen from the Hydrogen Storage Sub-system 106 (FIG. 2) on Hydrogen Connection Output 20. The heat produced by the Hydrogen Fuel Cells 103 during the production of electrical power is transferred to the Steam Heat Exchanger 18 by the Heat Connection A 36. The Steam Heat Exchanger 18 produces steam needed by the Flash Type Distilling Plant 30 (FIG. 2) for creating a vacuum on the evaporation chambers. Residual heat from the Steam Heat Exchanger 18 is transferred to the Input Heat Exchanger 102 through Heat Connection B 38. The Input Heat Exchanger 102 is for heating the Input Water 35. Excess heat of the Input Heat Exchanger 102 is transferred to the Heat Recirculation Unit 145 by the Exhaust Heat Connection 144. The Hydrogen Fuel Cell(s) 103 provides power needed by the Flash Type Distilling Plant 30 (FIG. 2) on the Power Connection 34. The Hydrogen Fuel Cell(s) 103 produce Water By-product 37 as the result of the hydrogen combing with oxygen in the Hydrogen Fuel Cell 103 with oxygen from the Atmosphere Connection 48. The power usage is monitored on Power Connection 34 verifying that the expected power usage is actually being used by the Modular-Scalable Desalinization Plant 101. The Steam Heat Exchanger 18 temperature is monitored to determine that the Steam Heat Exchanger 18 is producing the necessary steam and pressure required in Steam Connection 11. The Steam Connection 11 pressure is monitored to verify the Steam Heat Exchanger 18 is producing the require pressure.

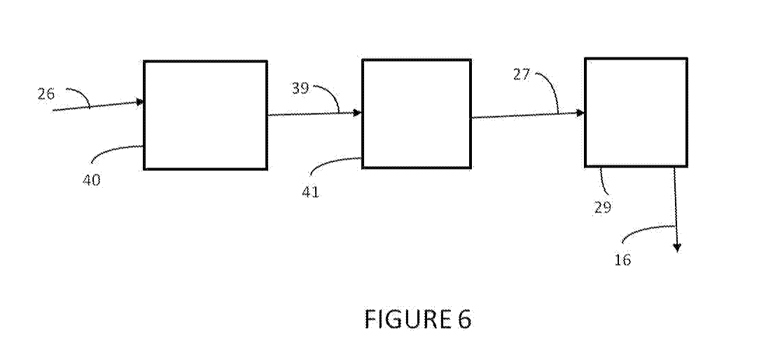

FIG. 6 shows the De-ionized Water Production Sub-system 14 (FIG. 3) is comprised of a Water Pre-Filter 40, a Water De-ionizer 41, and a De-ionized Water Storage Tank 29. The Water Deionizer Sub-system 14 (FIG. 3) receives Potable Water 26 and produces de-ionized water which is stored in the De-ionized Water Storage Tank 29. The de-ionized water is sourced with De-ionized Water Connection 16 to the Hydrogen Generator 108 (FIG. 3). The Filtered Water 39 and the DI-water Connection to Di-Storage 27 pressures are monitored verifying that the Filtered Water 39 pressure is greater than the DI-water Connection to Di-Storage 27. The Di-water Storage Tank 29 level is monitored for preventing it from being over-filled or from reaching empty and allowing the control of the off or on, respectively, of the Water De-ionizer 41.

FIG. 3 further shows the Hydrogen Generator 108 uses the de-ionized water from the De-ionized Water Storage Tank 29 on De-ionized Water Connection 16 and Power Source 32 producing hydrogen and delivering it to the Hydrogen Storage Sub-system 106 (FIG. 2). The temperature of the Input Water 35 (FIG. 5) is monitored and the output Heated Input Brine Water's 104 (FIG. 5) temperature is controlled to be the minimum temperature required for water-flash to occur at the atmospheric pressure level of each evaporator stage. The heat-exchanger 102 (FIG. 5) is controlled to raise or lower the temperature of the Input Water 35 (FIG. 5) to make the Heated Input Brine Water 104 (FIG. 5) the minimum temperature for water-flash to occur. The atmospheric pressure of each evaporator stage is monitored and controlled so that the vacuum is the minimum for optimum water-flash. The Steam Heat Exchanger 18 (FIG. 5) is controlled to maintain the minimum steam pressure required to create the vacuum necessary in the Flash Type Distilling Plant 30 (FIG. 2) evaporators.

The capacities of the Hydrogen Storage Sub-system 106 (FIG. 2) and the Hydrogen Production Sub-system 21 (FIG. 2) are key for providing Twenty Four hour operation. During the period that power is available, the Hydrogen Production Sub-system 21 (FIG. 2) must be sized to produce enough hydrogen to power the Power Generation Sub-system 17 (FIG. 2) for the fraction of the Twenty Four hour period when there is no Power Source 32 available. Also, the Hydrogen Storage Sub-system 106 (FIG. 2) must be sized to store the hydrogen quantity needed for that fraction of the Twenty Four hour period. The use of solar power as the Power Source 32 (FIG. 2) eliminates the use of grid power and shifts the cost of require power to the investment require in the solar power field. The Power Source 32 is comprised of solar power and Excess Generated Power 155 from the Power Generation Sub-system 17 (FIG. 5).

If it is desired to use off-peak priced grid power for the Power Source 32 (FIG. 2) then the Hydrogen Production Sub-system 21 (FIG. 2) must be sized to produce enough hydrogen during off-peak priced grid power to power the Power Generation Sub-system 17 (FIG. 2) for the fraction of the Twenty Four hour period when there is only peak priced power available. The Hydrogen Production Sub-system 21 (FIG. 2) will be turned off during periods of peak priced power from the grid. The ability of the MSD 101 (FIG. 1) to shift the cost of power from the higher peak grid power price to the lower price of the off-peak grid power significantly reduces the cost per cubic meter of Potable Water 12 (FIG. 1). Given the geographic location of the MSD—Modular-Scalable Desalinization Plant 101 (FIG. 1) installation a combination of both solar and off-peak grid power can be configured to meet the end-user's needs.

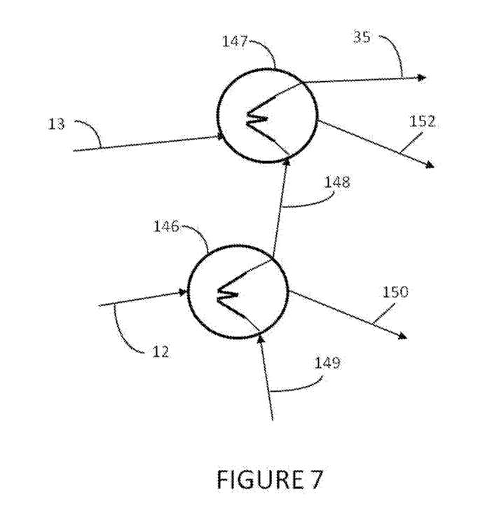

FIG. 7 Heat Recovery Stage shows a means to recover heat from the Potable Water 12 (FIG. 1) and from the Brine 13 (FIG. 1). The Potable Water 12 is routed to the Potable Water Heat Exchanger 146 (FIG. 7) used to heat the Alternate Input Water 149 (FIG. 7). The output of the Potable Water Heat Exchanger 146 is Heated Input Water 148 (FIG. 7). The alternate Potable Water 150 (FIG. 7) is output from Potable Water Heat Exchanger 146.

The Brine Heat Exchanger 147 (FIG. 7) accepts input of the Heated Input Water 148 which is then heated by the input Brine 13 and the alternate output Brine 152 exits the Brine Heat Exchanger 147. Input Water 35 (FIG. 7) is output to the Input Heat Exchanger 102 (FIG. 5).

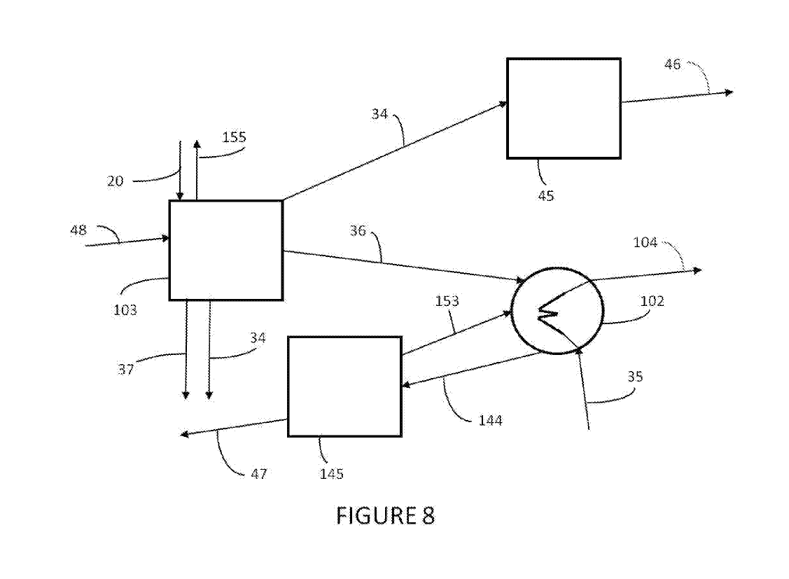

FIG. 8 shows the Alternate Power Generation Sub-system 17 (FIG. 2) is comprised of one too many Hydrogen Fuel Cells 103, a Air-Compressor 45 and a Input Heat Exchanger 102. The Hydrogen Fuel Cells 103 receives hydrogen from the Hydrogen Storage Sub-system 106 (FIG. 2) on Hydrogen Connection Output 20. The Hydrogen Fuel Cells 103 produce electrical power transferred to the Air-Compressor 45 by the Power Connection 34. The Air-Compressor 45 produces compressed air transferred by Compressed Air Connection 46 to the Multi-Effect Plate Evaporator 30 (FIG. 2) for creating a vacuum on the evaporation chambers. The heat produced by the Hydrogen Fuel Cells 103 is transferred to the Input Heat Exchanger 102 through Heat Connection 36. The Input Heat Exchanger 102 is for heating the Input Water 35. Excess heat of the Input Heat Exchanger 102 is vented at the Excess Heat Vent 144. The Excess Heat Vent 144 is connected to the Heat Recirculation Unit 145. The Heat Recirculation Unit 145 feeds heat back to the Input Heat Exchanger 102 by the Reusable Heat Connection 153. The Hydrogen Fuel Cell(s) 103 provides power needed by the Multi-Effect Plate Evaporator 30 (FIG. 2) on the Power Connection 34. The Hydrogen Fuel Cell(s) 103 produce Water By-product 37 as the result of the hydrogen combing with oxygen in the Hydrogen Fuel Cell 103 with oxygen from the Atmosphere 33. The power usage is monitored on Power Connection 34 verifying that the expected power usage is actually being used by the Modular-Scalable Desalinization Plant W/Compressor 101. The Air-Compressor 45 pressure output is monitored verifying that it is producing sufficient air pressure for the production of a vacuum needed by the Multi-Effect Plate Evaporator 30.

What is claimed is:

1. A hydrogen fuel cell powering thermal desalinization utilizing combined heat and electrical power comprising: a power generation sub-system; a thermal desalinization unit; a hydrogen storage sub-system; a hydrogen production sub-system, wherein the power generation sub-system includes one too many hydrogen fuel cell(s), a means for heat recirculation, a means making a vacuum, a means to heat the input water, wherein the hydrogen production sub-system includes a hydrogen generator, a de-ionized water production sub-system and a power source, wherein the hydrogen storage sub-system includes one too many hydrogen hydride tank(s), a control manifold with input/output selector, and wherein the thermal desalinization unit utilizes the heated input water and vacuum for producing potable water.

2. The hydrogen production sub-system according to claim 1, wherein the power source is comprised of power from a solar power array and the power generation sub-system excess power.

3. The hydrogen production sub-system according to claim 1, wherein the power source is comprised of power from the grid power and power generation sub-system excess power.

4. The power generation sub-system according to claim 1, wherein the means to heat the input brine water comprises a input water heat exchanger, heat provided by the fuel cell(s).

5. The power generation sub-system according to claim 1, wherein the means to heat the input water comprises a series of heat exchangers including a input water heat exchanger with heat provided by the fuel cell(s), a input water heat exchanger with heat provided by the exiting brine water, and a potable water heat exchanger with heat provided by the exiting potable water.

6. The power generation sub-system according to claim 1, wherein the means for making a vacuum is a steam producing heat exchanger with the high pressure steam used for producing a vacuum.

7. The power generation sub-system according to claim 1, wherein the means for making a vacuum is a compressor.
